(19) United States
(12) Patent Application Publication
(10) Pub. No.: US 2026/0125543 A1
(43) Pub. Date: May 7, 2026

(54) TIRE

(71) Applicant: COMPAGNIE GENERALE DES ETABLISSEMENTS MICHELIN, Clermont-Ferrand (FR)

(72) Inventors: ALINE RIOU, Clermont-Ferrand (FR); GWENAEL AZOU, Clermont-Ferrand (FR)

(21) Appl. No.: 19/118,272

(22) PCT Filed: Oct. 4, 2023
(86) PCT No.: PCT/FR2023/051537

§ 371 Date: Apr. 3, 2025

(30) Foreign Application Priority Data
Oct. 4, 2022 (FR) 2210158

(51) Int. Cl. C08L 7/00; B60C 1/00; B60C 11/00; B60C 15/06

(52) U.S. Cl. CPC C08L 7/00; B60C 1/0016; B60C 11/0008; B60C 11/005; B60C 15/0635; B60C 2001/005; B60C 2011/0025; C08L 2205/025; C08L 2205/03; C08L 2312/04

(57) ABSTRACT

The present invention relates to a tyre (10) comprising, in the beads or in the tread, a rubber composition based on:
an elastomeric matrix predominantly by mass comprising natural rubber;
at least 65 phr of reinforcing fillers, the reinforcing fillers consisting of 40 to 70 phr of pyrolysis carbon black and 10 to 40 phr of carbon black, the ratio (mass of pyrolysis carbon black)/(total mass of reinforcing fillers) ranging from 0.60 to 0.75;
10 to 20 phr of a reinforcing resin mixture, the reinforcing resin mixture comprising a cardanol-based phenolic resin, the ratio (mass of cardanol-based phenolic resin)/(total mass of reinforcing resins) ranging from 0.1 to 0.7;
a curing agent; and
a crosslinking system.

### FIELD OF THE INVENTION

The present invention relates to a tyre, in particular for passenger vehicles.

### TECHNOLOGICAL BACKGROUND

Tyres for passenger vehicles usually include:
two beads intended to come into contact with a mounting support;
two sidewalls extending the beads radially outwards and coming together in a crown comprising a tread and a crown reinforcement;
at least one carcass reinforcement extending radially in each sidewall and axially in the crown, radially on the inside of the crown reinforcement.

Each bead comprises highly-stressed rubber compositions which must have a high level of stiffness while at the same time offering reduced rolling resistance.

This problem is also found in tyres comprising a tread comprising a radially outer layer intended to be in contact with the ground on which the tyre runs when the tyre is new and a radially inner layer arranged radially inside the radially outer layer when the tyre is new. Specifically, in certain tyres, it is advantageous for the radially inner layer to have a high level of stiffness while at the same time offering reduced rolling resistance.

Stiffening may be obtained by means of reinforcing fillers and/or by incorporating reinforcing resins into the rubber compositions.

In recent years, limiting the environmental impact of the manufacture and use of tyres has become a major challenge for the manufacturers in the sector. Research and development initiatives for producing tyres comprising rubber compositions based on recycled or biobased materials have increased in number. The formulation of such compositions is not trivial, the major difficulty being to reconcile good processability of the composition, a high level of stiffness and low rolling resistance of the composition in the cured state.

Thus, the need remains to provide rubber compositions which reduce the environmental footprint of tyres by incorporating recycled and/or biobased materials and which satisfy a good stiffness/hysteresis/processability compromise, these compositions being able most particularly to be incorporated into the bead(s) of a tyre or into the treads.

### BRIEF DESCRIPTION OF THE INVENTION

The present invention relates to a tyre comprising two beads, at least one of the beads comprising a rubber composition based on:
an elastomeric matrix predominantly by mass comprising natural rubber;
at least 65 phr of reinforcing fillers, the reinforcing fillers consisting of 40 to 70 phr of pyrolysis carbon black and 10 to 40 phr of carbon black, the ratio (mass of pyrolysis carbon black)/(total mass of reinforcing fillers) ranging from 0.60 to 0.75;
10 to 20 phr of a reinforcing resin mixture, the reinforcing resin mixture comprising a cardanol-based phenolic resin, the ratio (mass of cardanol-based phenolic resin)/(total mass of reinforcing resins) ranging from 0.1 to 0.7, preferentially from 0.2 to 0.6, more preferentially from 0.4 to 0.6;
a curing agent; and
a crosslinking system.

The present invention also relates to a tyre comprising a tread comprising:
a radially outer layer intended to be in contact with a ground on which the tyre runs when the tyre is new, and
a radially inner layer arranged radially inside the radially outer layer when the tyre is new,

the radially inner layer comprising a rubber composition based on:
an elastomeric matrix predominantly by mass comprising natural rubber;
at least 65 phr of reinforcing fillers, the reinforcing fillers consisting of 40 to 70 phr of pyrolysis carbon black and 10 to 40 phr of carbon black, the ratio (mass of pyrolysis carbon black)/(total mass of reinforcing fillers) ranging from 0.60 to 0.75;
10 to 20 phr of a reinforcing resin mixture, the reinforcing resin mixture comprising a cardanol-based phenolic resin, the ratio (mass of cardanol-based phenolic resin)/(total mass of reinforcing resins) ranging from 0.1 to 0.7, preferentially from 0.2 to 0.6, more preferentially from 0.4 to 0.6;
a curing agent; and
a crosslinking system.

Other aspects of the invention are as described below and in the claims.

### Definitions

The expression “composition based on” should be understood as meaning a composition including the mixture and/or the product of the in situ reaction of the various constituents used, some of these constituents being able to react and/or being intended to react with each other, at least partially, during the various phases of manufacture of the composition; it thus being possible for the composition to be in the completely or partially crosslinked state or in the non-crosslinked state.

The expression “part by weight per hundred parts by weight of elastomer” (or phr) should be understood as meaning the part by mass per hundred parts by mass of elastomer or rubber, the two terms being synonymous.

The term “elastomer matrix” or “elastomeric matrix” means all of the elastomer(s) present in the rubber composition.

For the purposes of the present invention, the term “predominantly” means that the compound is predominant among the compounds of the same type in the composition, that is to say that it is the one which represents the greatest amount by mass among the compounds of the same type. In other words, the mass of this compound represents at least 51% of the total mass of the compounds of the same type in the composition. By way of example, in a system comprising just one elastomer, the latter is predominant within the meaning of the present invention; and in a system comprising two elastomers, the predominant elastomer represents more than half of the total mass of the elastomers, in other words the mass of this elastomer represents at least 51% of the total mass of the elastomers. Similarly, a “predominant” filler is the one representing the greatest mass among the fillers of the composition. In other words, the mass of this filler represents at least 51% of the total mass of the fillers in the composition.

In the present text, unless expressly indicated otherwise, all the percentages (%) indicated are mass percentages (%).

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b). In the present document, when an interval of values is described by the expression “from a to b”, the interval represented by the expression “between a and b” is also and preferentially described.

The expression “radial” refers to a radius of the tyre. It is within this meaning that it is said, of a point P1, that it is “radially interior to” a point P2 (or “radially inside” the point P2) if it is closer to the axis of rotation of the tyre than the point P2. Conversely, a point P3 is said to be “radially exterior to” a point P4 (or “radially outside” the point P4) if it is further away from the axis of rotation of the tyre than the point P4. It will be said that a movement is “radially inwards (or outwards)” when the movement is in the direction of the shorter (or longer) radii. When it is a question of radial distances, this meaning of the term also applies.

The term “radial cross section” or “radial section” is understood here to mean a cross section or a section along a plane which contains the axis of rotation of the tyre.

An “axial” direction is a direction parallel to the axis of rotation of the tyre. A point P5 is said to be “axially interior to” a point P6 (or “axially inside” the point P6) if it is closer to the median plane of the tyre than the point P6. Conversely, a point P7 is said to be “axially exterior to” a point P8 (or “axially outside” the point P8) if it is further from the median plane of the tyre than the point P8. The “median plane” of the tyre is the plane which is perpendicular to the axis of rotation of the tyre and which is located equidistantly from the annular reinforcing structures of each bead.

A “circumferential” direction is the direction which, in each meridian cross-section plane, is perpendicular both to a radius of the tyre and to the axial direction.

The compounds comprising carbon mentioned in the description may be of fossil or biobased origin. In the latter case, they may be partially or totally derived from biomass or may be obtained from renewable starting materials derived from biomass. Polymers, plasticizers, fillers, and the like, are notably concerned.

### DETAILED DESCRIPTION OF THE INVENTION

The inventors have developed rubber compositions that meet the needs expressed. The compositions have good processability and thus allow a satisfactory stiffness/rolling resistance compromise to be achieved.

The present invention thus relates to a tyre (10) comprising, in the beads or in the tread, a rubber composition as described below.

More specifically, the present invention relates to a tyre comprising two beads, at least one of the beads comprising a rubber composition based on:
an elastomeric matrix predominantly by mass comprising natural rubber;
at least 65 phr of reinforcing fillers, the reinforcing fillers consisting of 40 to 70 phr of pyrolysis carbon black and 10 to 40 phr of carbon black, the ratio (mass of pyrolysis carbon black)/(total mass of reinforcing fillers) ranging from 0.60 to 0.75;
10 to 20 phr of a reinforcing resin mixture, the reinforcing resin mixture comprising a cardanol-based phenolic resin, the ratio (mass of cardanol-based phenolic resin)/(total mass of reinforcing resins) ranging from 0.1 to 0.7, preferentially from 0.2 to 0.6, more preferentially from 0.4 to 0.6;
a curing agent; and
a crosslinking system.

The present invention also relates to a tyre comprising a tread comprising:
a radially outer layer intended to be in contact with a ground on which the tyre runs when the tyre is new, and
a radially inner layer arranged radially inside the radially outer layer when the tyre is new,

the radially inner layer comprising a rubber composition based on:
an elastomeric matrix predominantly by mass comprising natural rubber;
at least 65 phr of reinforcing fillers, the reinforcing fillers consisting of 40 to 70 phr of pyrolysis carbon black and 10 to 40 phr of carbon black, the ratio (mass of pyrolysis carbon black)/(total mass of reinforcing fillers) ranging from 0.60 to 0.75;
10 to 20 phr of a reinforcing resin mixture, the reinforcing resin mixture comprising a cardanol-based phenolic resin, the ratio (mass of cardanol-based phenolic resin)/(total mass of reinforcing resins) ranging from 0.1 to 0.7, preferentially from 0.2 to 0.6, more preferentially from 0.4 to 0.6;
a curing agent; and
a crosslinking system.

The rubber composition may also comprise usual additives and processing aids.

The various constituents of the rubber composition may be as described below.

### Elastomeric Matrix

The elastomeric matrix predominantly by mass comprises natural rubber, typically more than 50 phr to 100 phr, preferably 75 to 100 phr, of natural rubber.

The elastomeric matrix may comprise another elastomer chosen from the group consisting of diene elastomers and mixtures thereof.

The term “diene elastomer”, whether natural or synthetic, should be understood, in a known manner, as meaning an elastomer consisting, at least partly (i.e. a homopolymer or a copolymer) of diene monomer units (monomers bearing two conjugated or non-conjugated carbon-carbon double bonds).

These diene elastomers can be classified into two categories: “essentially unsaturated” or “essentially saturated”. The term “essentially unsaturated” generally means a diene elastomer resulting at least in part from conjugated diene monomers having a content of units of diene origin (conjugated dienes) which is greater than 15% (mol %); thus it is that diene elastomers such as butyl rubbers or copolymers of dienes and of α-olefins of EPDM type do not come within the preceding definition and can notably be described as “essentially saturated” diene elastomers (low or very low content, always less than 15%, of units of diene origin).

The term “diene elastomer that may be used” particularly means:
(a)—any homopolymer obtained by polymerization of a conjugated or non-conjugated diene monomer containing from 4 to 18 carbon atoms;
(b)—any copolymer obtained by copolymerization of a conjugated or non-conjugated diene containing from 4 to 18 carbon atoms and of at least one other monomer.

The other monomer can be ethylene, an olefin or a conjugated or non-conjugated diene. Conjugated dienes that are suitable include conjugated dienes containing from 4 to 12 carbon atoms, in particular 1,3-dienes, notably such as 1,3-butadiene and isoprene.

Olefins that are suitable include vinylaromatic compounds containing from 8 to 20 carbon atoms and aliphatic α-monoolefins containing from 3 to 12 carbon atoms.

Vinylaromatic compounds that are suitable include, for example, styrene, ortho-, meta- or para-methylstyrene, the “vinyltoluene” commercial mixture or para-(tert-butyl) styrene. Aliphatic α-monoolefins that are suitable notably include acyclic aliphatic α-monoolefins containing from 3 to 18 carbon atoms.

More particularly, the diene elastomer that may be used in the compositions may be:
(a′)—any homopolymer obtained by polymerization of a conjugated diene monomer containing from 4 to 12 carbon atoms;
(b′)—any copolymer obtained by copolymerization of one or more conjugated dienes with one another or with one or more vinylaromatic compounds containing from 8 to 20 carbon atoms;
(c′)—any copolymer obtained by copolymerization of one or more conjugated or non-conjugated dienes with ethylene, an α-monoolefin or a mixture thereof, for instance the elastomers obtained from ethylene, from propylene with a non-conjugated diene monomer of the abovementioned type.

Preferentially, the diene elastomer is chosen from the group consisting of polybutadienes (BRs), natural rubber (NR), synthetic polyisoprenes (IR), butadiene copolymers, isoprene copolymers and mixtures of these elastomers. The butadiene copolymers are particularly chosen from the group consisting of styrene/butadiene copolymers (SBRs). The diene elastomer may be modified, i.e. either coupled and/or star-branched, or functionalized, or coupled and/or star-branched and simultaneously functionalized.

Thus, the diene elastomer can be coupled and/or star-branched, for example by means of a silicon or tin atom which connects the elastomer chains together.

The diene elastomer can be simultaneously or alternatively functionalized and comprise at least one functional group. The term “functional group” means a group comprising at least one heteroatom chosen from Si, N, S, O or P. Particularly suitable as functional groups are those comprising at least one function, such as: silanol, an alkoxysilane, a primary, secondary or tertiary amine which is cyclic or non-cyclic, a thiol or an epoxide.

In certain embodiments, the rubber composition that is useful in the context of the invention also comprises a styrene/butadiene copolymer (SBR).

In certain embodiments, the rubber composition that is useful in the context of the invention comprises an elastomeric matrix consisting of natural rubber and a styrene/butadiene copolymer (SBR), the natural rubber being predominant by mass in the elastomeric matrix.

In certain embodiments, the rubber composition that is useful in the context of the invention comprises an elastomeric matrix consisting of natural rubber (100 phr of natural rubber).

### Reinforcing Filler

The rubber composition that is useful in the context of the present invention comprises at least 65 phr, typically from 65 to 110 phr, of reinforcing fillers, the reinforcing fillers consisting of from 40 to 70 phr of pyrolysis carbon black and from 10 to 40 phr of carbon black (referred to as “conventional”), the ratio (mass of pyrolysis carbon black)/(total mass of reinforcing fillers) ranging from 0.60 to 0.75.

In certain embodiments, the reinforcing fillers consist of 10 to 30 phr, preferably 20 to 30 phr, of carbon black (referred to as “conventional”) and 40 to 65 phr, preferably 45 to 65 phr, of pyrolysis carbon black.

### Pyrolysis Carbon Black

For the purposes of the present invention, the term “pyrolysis carbon black” means a carbon black resulting from a pyrolysis process of a material comprising at least a carbon-based polymer and a carbon black, referred to hereinbelow as the material to be pyrolysed, for example in the context of the recycling of such a material. The physical state in which the material to be pyrolysed is provided is not important, whether it is in the form of a powder, granules, a strip, or any other form, in the crosslinked or non-crosslinked state.

Preferentially, the material to be pyrolysed may be recovered from manufactured articles or from products generated during their manufacture/production (such as by-products or scraps); these manufactured articles being able to be chosen from the group consisting of pneumatic tyres, non-pneumatic tyres, industrial conveyor belts, transmission belts, rubber seals, rubber hoses, shoe soles and windscreen wipers. Even more preferentially, the pyrolysis carbon black that may be used in the context of the present invention is a carbon black obtained from a pyrolysis process of which the material to be pyrolysed is derived from manufactured articles chosen from the group consisting of pneumatic tyres and non-pneumatic tyres.

In the context of the present invention, “pyrolysis” means any type of thermal decomposition in the absence of oxygen and the raw material of which is the material to be pyrolysed as defined above. Pyrolysis carbon blacks thus differ from “industrial” and/or “ASTM-grade” carbon blacks in that the carbon-based raw material used for the pyrolysis is a material comprising at least a carbon-based polymer and a carbon black and not materials derived from petroleum cuts or derived from coal or else from oils of natural origin.

The pyrolysis carbon blacks that may be used in the context of the present invention differ from known carbon blacks such as industrial carbon blacks, in particular “furnace” carbon blacks, notably by a higher ash content.

Preferentially, the pyrolysis carbon black that may be used in the context of the present invention has an ash content ranging from 5% to 30% by weight, more preferentially ranging from 8% to 25% by weight, even more preferentially ranging from 10% to 22% by weight, relative to the total weight of the pyrolysis carbon black.

Preferentially, the pyrolysis carbon black that may be used in the context of the present invention has a sulfur content of greater than 2% by weight, preferably ranging from 2.5% to 5% by weight, relative to the total weight of the pyrolysis carbon black.

Preferentially, the pyrolysis carbon black that may be used in the context of the present invention has a zinc content of greater than or equal to 2% by weight, preferably ranging from 2.5% to 8% by weight, relative to the total weight of the pyrolysis carbon black. Preferentially, the pyrolysis carbon black that may be used in the context of the present invention has an STSA specific surface area measured in accordance with the standard ASTM D 6556-2021 within a range extending from 20 to 200 m²/g, more preferentially extending from 30 to 90 m²/g.

Preferentially, the pyrolysis carbon black that may be used in the context of the present invention has a void volume measured in accordance with the standard ASTM D7854 (2018) and at a pressure of 50 MPa within a range extending from 30 to 60 ml/100 g, more preferentially extending from 35 to 55 ml/100 g.

The ash content is determined by calcination in platinum dishes in a muffle furnace at 825° C. according to the following protocol. A dish is identified in advance before each series of measurements and is tared to within 0.1 mg and the mass is denoted P0. 5 g of pyrolysis carbon black sample are introduced into the dish, which is weighed precisely to within 0.1 mg; this mass is denoted P1. The dish and its contents are pre-calcined using a Bunsen burner until smoke appears and the product ignites. Once the product has burnt completely, the dish and its contents are placed in a muffle furnace heated at 825° C. for 1 hour. After 1 hour, the dish is removed from the furnace and immediately placed in a desiccator at room temperature. When the dish and the ashes have returned to ambient temperature, the dish is weighed again to obtain the mass P2. Finally, it is possible to obtain the ash content (% ash) using the formula below:

$$\% ash = \frac{P 2 - P 0}{P 1 - P 0} \times 100$$

The content of zinc in the pyrolysis carbon black is determined after calcination of the sample, then uptake of the ashes in an acidic medium and assay by ICP-AES (inductively coupled plasma atomic emission spectroscopy). The ashes are obtained by performing the above protocol. About exactly 100 mg of ashes are taken (test sample) and introduced into a PFA (perfluoroalkoxy) tube for a HotBlock hot plate. 8 ml of 37% concentrated hydrochloric acid, 3 ml of 65% concentrated nitric acid and 0.5 ml of 40% hydrofluoric acid are then added. The tube is closed with a stopper and is heated at 130° C. for 2 h. After cooling, the contents are then transferred using ultrapure water into a 100 ml PTFE (polytetrafluoroethylene) volumetric flask already containing 2 g of boric acid (to neutralize the hydrofluoric acid). Ultrapure water is added up to the graduation mark. The solution obtained is diluted 100-fold, by taking 1 ml and placing it in a 100 ml PFTE flask already containing 8 ml of 37% concentrated hydrochloric acid, 3 ml of 65% concentrated nitric acid, 0.5 ml of 40% hydrofluoric acid and 2 g of boric acid. This diluted solution is then filtered on a 0.45 μm GHP syringe filter before being analysed by inductively coupled plasma atomic emission spectroscopy (ICP-AES). Prior to the analysis of the diluted solution, at least five standards are analysed by ICP-AES at zinc concentrations of 0, 0.5, 1, 2 and 5 mg/l. These standards were prepared in 100 ml volumetric flasks, by dilution of a commercial solution certified to a zinc concentration of 1 g/l.

These volumetric flasks already contain 8 ml of 37% concentrated hydrochloric acid, 3 ml of 65% concentrated nitric acid, 0.5 ml of 40% hydrofluoric acid and 2 g of boric acid. The standard solutions are analysed by ICP-AES at a wavelength of λZn=202.613 nm. For each standard concentration (c), the intensity of the zinc signal IZn is plotted on a graph IZn=f (c), which corresponds to the calibration curve (of type y=ax+b). The solution of the sample (diluted solution) of unknown concentration is then measured under the same conditions as the standards. The measured intensity is linked to the concentration by means of the previously obtained calibration curve. The concentration [c] ashes in % by mass is thus obtained directly by the software, since the test sample and the volume have been previously recorded. The concentration of zinc in the pyrolysis black [c] black in % by mass is obtained by the following equation:

$${[ c ]}_{b l a c k} = {[ c ]}_{a s h} \times 100 \times \% ash$$

The content of sulfur in the pyrolysis carbon blacks is determined using a LECO furnace. LECO sulfur analysers are designed to measure, in particular, the content of sulfur in organic and/or inorganic materials by combustion and nondispersive infrared detection. Before measuring the content of sulfur in the sample, the boats are cleaned and the furnace is calibrated. The boats for the LECO furnace are cleaned beforehand: this involves analysing the empty boat, under the same conditions as the samples. The calibration curve is prepared using a commercial standard called “BBOT” having a purity of greater than 99.99% and a guaranteed content of carbon (C), hydrogen (H), nitrogen (N), oxygen (O) and sulfur(S). This content is as follows C %: 72.52; H % 6.09; N % 6.51; O % 7.43 and S % 7.44. About exactly 10±3, 20±3 and 40±3 mg of BBOT are weighed into a boat. The standard/boat assembly is introduced into the combustion furnace, regulated at 1350° C. under pure oxygen. The combination of the temperature of the furnace and the analysis flow rate causes the combustion of the sample and the release of sulfur and/or carbon in the form of SO₂(g). After a time of 20 s, oxygen starts to flow through the lance in order to accelerate the combustion of materials that are difficult to burn. The sulfur and/or the carbon, in the form of SO₂(g), are entrained by a stream of oxygen through the infrared detection cells. The instrument software plots a curve linking the mass of standard introduced and the observed response (area) on the detector. A calibration curve is thus obtained. After having carefully cleaned the sampling equipment, about exactly 80±5 mg of pyrolysis carbon black are weighed out and introduced into a boat for the LECO furnace. The observed area of the SO₂ peak is linked to the concentration by means of the calibration curve. Using the mass of sample introduced into the boat, the instrument software then calculates the % by mass of sulfur in the sample.

Pyrolysis carbon blacks are sold, for example, by the company BlackBear under the reference BBCT30 or by the company Scandinavian Enviro Systems under the reference P550.

In certain embodiments, the rubber composition comprises from 40 to 65 phr and preferably from 45 to 65 phr of pyrolysis carbon blacks.

### Carbon Black

Any carbon black, notably the blacks conventionally used in tyres or their treads, is suitable for use as carbon blacks, in particular industrial carbon blacks, more specifically “furnace” carbon blacks.

Among the carbon blacks, mention will more particularly be made of the reinforcing carbon blacks of the 100, 200 and 300 series, or the blacks of the 500, 600 or 700 series (ASTM D-1765-2017 grades), for instance the N115, N134, N234, N326, N330, N339, N347, N375, N550, N683 and N772 blacks. Preferably, the carbon blacks are selected from the group consisting of the blacks of the 300, 500, 600 and 700 series.

The carbon blacks may be used in isolated form, as commercially available, or in any other form, for example as support for some of the rubber additives used. The carbon blacks might, for example, be already incorporated into the diene elastomer, notably an isoprene elastomer, in the form of a masterbatch (see, for example, patent applications WO 97/36724-A2 and WO 99/16600-A1).

In certain embodiments, the rubber composition comprises from 10 to 30 phr, or from 20 to 30 phr, of “conventional” carbon blacks, for example ASTM N326 or N550 carbon blacks.

### Reinforcing Resins

The composition that is useful in the context of the present invention comprises from 10 to 20 phr of a reinforcing resin mixture, the reinforcing resin mixture comprising a cardanol-based phenolic resin, the ratio (mass of cardanol-based phenolic resin)/(total mass of reinforcing resins) ranging from 0.1 to 0.7, preferentially from 0.2 to 0.6, more preferentially from 0.4 to 0.6.

### Cardanol-Based Phenolic Resins

Cardanol-based phenolic resins are phenolic resins obtained by reaction between cardanol and a methylene donor. Compounds known as “methylene donors” are well known to those skilled in the art. The methylene donor may, for example, be a formaldehyde.

Cardanol is a phenolic lipid obtained in particular from anacardic acid, the main component of cashew balsam, surrounding the cashew nut.

An example of a cardanol-based phenolic resin is Durez 12686 sold by Sumitomo.

### Other Reinforcing Resins

The reinforcing resin mixture comprises at least one other reinforcing resin, typically chosen from phenolic resins, epoxy resins, benzoxazine resins, polyurethane resins, aminoplast resins, etc.

The reinforcing resins conventionally used in rubber compositions for tyres are based on a methylene acceptor/donor system. The terms “methylene acceptor” and “methylene donor” are well known to a person skilled in the art and are widely used to denote compounds that are capable of reacting together (crosslinking). The crosslinking of the resin is brought about, during the curing of the rubber matrix, by the formation of methylene (—CH₂—) bridges between the carbons in the ortho and/or para positions of the phenolic rings of the resin and the methylene donor, thus creating a three-dimensional resin network which is superimposed on and interpenetrated with the reinforcing filler/elastomer network, on the one hand, and with the elastomer/sulfur network, on the other hand (if the crosslinking agent is sulfur). Examples of such methylene acceptors and donors are described in WO 02/10269.

There are many other reinforcing resins that can be used in the context of the present invention. Mention may notably be made, by way of example, of those described in patent applications WO 2011/029938, WO 2008/080535, WO 2014/016346, WO 2013/017422 or WO 2014/016344.

Preferably, the mixture of reinforcing resins comprises a phenolic resin chosen from the group consisting of resins based on polyphenol, on alkylphenol, on aralkylphenol and mixtures thereof. Preferably, the reinforcing resin is a phenolic resin chosen from the group consisting of resins based on hydroxybenzene, on bisphenol (preferably diphenylolpropane or diphenylolmethane), on naphthol, on cresol, on t-butylphenol, on octylphenol, on nonylphenol, on resorcinol, on phloroglucinol, on xylenol (notably 3,5-xylenol), on 1-naphthol, on 2-naphthol, on 1,5-naphthalenediol, on 2,7-naphthalenediol, on pyrogallol, on 2-methylhydroquinone, on 4-methylcatechol, on 2-methylcatechol, on orcinol (5-methylbenzene-1,3-diol), on hydroquinone (benzene-1,4-diol) and on mixtures thereof.

The reinforcing resin may also be an epoxy resin chosen from the group consisting of aromatic epoxide compounds, alicyclic epoxide compounds, aliphatic epoxide compounds and mixtures thereof; preferably, the reinforcing resin is an epoxy resin chosen from the group consisting of 2,2-bis [4-(glycidyloxy)phenyl] propane, poly [(o-cresyl glycidyl ether)-co-formaldehyde], poly [(phenyl glycidyl ether)-co-formaldehyde], poly [(phenyl glycidyl ether)-co-(hydroxybenzaldehyde glycidyl ether)] and mixtures thereof.

The reinforcing resins within the meaning of the present invention should not be confused with “plasticizing” hydrocarbon resins, which are by nature at least partially miscible (i.e. compatible) at the contents used with the polymer compositions for which they are intended, so as to act as true diluents. Plasticizing hydrocarbon resins have notably been described, for example, in patent application WO 2013/092096 or in the work entitled “Hydrocarbon Resins” by R. Mildenberg, M. Zander and G. Collin (New York, V C H, 1997, ISBN 3-527-28617-9), Chapter 5 of which is devoted to their applications, notably in the tyre rubber field (5.5. “Rubber Tires and Mechanical Goods”). They can be aliphatic, cycloaliphatic, aromatic, hydrogenated aromatic or of the aliphatic/aromatic type.

The composition that is useful in the context of the present invention also comprises a reinforcing resin co-agent (sometimes known as a curing agent) that is well known to those skilled in the art. A person skilled in the art knows which co-agent to combine with which reinforcing resin based on his general knowledge or on the abovementioned documents. Said skilled person understands that the reinforcing resin co-agent is at least difunctional so that it can form a three-dimensional resin network with the reinforcing resin.

The reinforcing resin co-agent may be chosen from the group consisting of methylene donors, polyaldehydes, polyamines, polyimines, polyamines, polyaldimines, polyketimines, acid anhydrides and mixtures thereof.

When the reinforcing resin used is a phenolic resin, the reinforcing resin co-agent is preferably a methylene donor chosen from the group consisting of hexamethylenetetramine, hexa(methoxymethyl) melamine, hexa (ethoxymethyl) melamine, paraformaldehyde polymers, N-methylol derivatives of melamine, and mixtures thereof, preferably from the group consisting of hexamethylenetetramine, hexa(methoxymethyl) melamine, hexa (ethoxymethyl) melamine and mixtures thereof.

When the reinforcing resin used is an epoxy resin, the reinforcing resin co-agent is preferably an amino curing agent chosen from the group consisting of polyamines (notably aliphatic polyamines, alicyclic polyamines, aliphatic amines and aromatic polyamines), dicyandiamides, polyhydrazides, imidazole compounds, sulfonium salts, onium salts, ketimines, acid anhydrides and mixtures thereof; preferably, the reinforcing resin co-agent is an amino curing agent chosen from the group consisting of ethylenediamine, diethylenetriamine, triethylenetetramine, 1,8-diaminooctane, 1,3-bis(aminomethyl)cyclohexane, m-xylylenediamine, p-xylylenediamine, m-phenylenediamine, 2,2-bis(4-aminophenyl) propane, diaminodiphenylmethane, 3,5-diethyl-2,4-diaminotoluene, 3,5-diethyl-2,6-diamintoluene, methylthiotoluenediamine, dimethylthiotoluenediamine, diaminodiphenyl sulfone, 2,2′-bis(4-aminophenyl)-p-diisopropylbenzene, 3,3′-diaminobenzidine, 4,4′-(4,4′-isopropylidenediphenoxy)bis(phthalic anhydride) polyanhydride, pyromellitic dianhydride and mixtures thereof.

The curing agent/reinforcing resin mixture mass ratio typically ranges from 0.2 to 0.5.

In certain embodiments, the composition that is useful in the context of the present invention comprises from 10 to 20 phr of a reinforcing resin mixture, the reinforcing resin mixture comprising, or consisting of, a cardanol-based phenolic resin and at least one other reinforcing resin chosen from phenolic resins, epoxy resins, benzoxazine resins, polyurethane resins and aminoplast resins.

In certain embodiments, the composition that is useful in the context of the present invention comprises from 10 to 20 phr of a reinforcing resin mixture, the reinforcing resin mixture consisting of a cardanol-based phenolic resin and another phenolic resin, preferably another hydroxybenzene-based phenolic resin.

In these embodiments, the ratio (mass of cardanol-based phenolic resin)/(total mass of reinforcing resins) ranges from 0.1 to 0.7, preferentially from 0.2 to 0.6, even more preferentially from 0.4 to 0.6.

### Crosslinking System

The composition that is useful in the context of the invention comprises a crosslinking system.

The crosslinking system may be any type of system known to those skilled in the art in the field of rubber compositions for tyres. It may notably be based on sulfur and/or on peroxide and/or on bismaleimides.

Preferentially, the crosslinking system is based on sulfur; it is then referred to as a vulcanization system. The sulfur can be provided in any form, notably in the form of molecular sulfur and/or of a sulfur-donating agent. At least one vulcanization accelerator is also preferentially present, and, optionally, also preferentially, use may be made of various known vulcanization activators, such as zinc oxide, stearic acid or an equivalent compound, such as stearic acid salts, and salts of transition metals, guanidine derivatives (in particular diphenylguanidine), or known vulcanization retarders.

Sulfur is used in a preferential content of between 0.5 and 12 phr, in particular between 1 and 10 phr, preferably between 3 and 9 phr.

The vulcanization accelerator is used in a preferential content of between 0.1 and 10 phr, more preferentially between 0.8 and 2 phr.

The vulcanization activator is used in a preferential content of between 1 and 10 phr, more preferentially between 3.3 and 10 phr.

Use may be made, as accelerator, of any compound that is capable of acting as an accelerator of the vulcanization of diene elastomers in the presence of sulfur, notably accelerators of the thiazole type, and also derivatives thereof, or accelerators of sulfenamide, thiuram, dithiocarbamate, dithiophosphate, thiourea and xanthate types. As examples of such accelerators, mention may notably be made of the following compounds: 2-mercaptobenzothiazyl disulfide (abbreviated as MBTS), N-cyclohexyl-2-benzothiazolesulfenamide (CBS), N, N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), tetrabenzylthiuram disulfide (TBZTD), zinc dibenzyldithiocarbamate (ZBEC) and mixtures of these compounds.

### Common Additives and Processing Aids

The composition that is useful in the context of the invention may also comprise all or some of the usual additives and processing aids known to those skilled in the art and usually used in rubber compositions for tyres, for instance plasticizers (such as plasticizing oils and/or plasticizing resins having or not having a tackifying nature), non-reinforcing fillers, pigments, pro-oxidative metal salts, protective agents, such as antiozone waxes, chemical antiozonants, antioxidants, or anti-fatigue agents.

### Manufacture of the Compositions

The composition that is useful in the context of the invention is manufactured in appropriate mixers using two successive preparation phases that are well known to those skilled in the art:
a first phase of thermomechanical working or kneading (known as the “non-productive” phase), that can be performed in a single thermomechanical step during which all the necessary constituents, notably the elastomer matrix, the fillers and the various other optional additives, with the exception of the crosslinking system, are introduced into an appropriate mixer, such as a standard internal mixer (for example of Banbury type). The incorporation of the filler into the elastomer may be performed in one or more portions while thermomechanically kneading. In the case where the filler is already incorporated, totally or partly, into the elastomer in the form of a masterbatch, as is described, for example, in patent applications WO 97/36724 or WO 99/16600, it is the masterbatch which is directly kneaded and, where appropriate, the other elastomers or fillers present in the composition which are not in masterbatch form, and also the optional various other additives, with the exception of the crosslinking system, are incorporated;

The non-productive phase is performed at high temperature, up to a maximum temperature of between 130° C. and 170° C., for a period of time generally of between 2 and 10 minutes.
a second phase of mechanical working (known as the “productive” phase), which is performed in an external mixer, such as an open mill, after cooling the mixture obtained during the first non-productive phase down to a lower temperature, typically below 110° C., for example between 40° C. and 100° C. The crosslinking system is then incorporated and the combined mixture is then mixed for a few minutes, for example between 1 and 30 min.

The final composition thus obtained is subsequently calendered, for example in the form of a sheet or of a plaque, in particular for laboratory characterization, or is extruded in the form of a rubber semi-finished (or profiled) element which can be used, for example, as an internal layer in a tyre.

The composition may be either in the uncured state (before crosslinking or vulcanization) or in the cured state (after crosslinking or vulcanization), or may be a semi-finished product which can be used in a tyre.

The crosslinking of the composition may be performed in a manner known to those skilled in the art, for example at a temperature of between 130° C. and 200° C., preferably under pressure, for a sufficient time which can vary, for example, between 5 and 90 min.

### Tyres

In accordance with a first embodiment of the invention, the compositions described previously are particularly useful for inclusion into at least one of the tyre beads and preferably in both tyre beads.

The bead of a tyre, also known as the “bead zone”, is one of the three main areas of a tyre (crown, sidewall and bead).

More specifically, the bead is the portion of the tyre intended to allow the attachment of the tyre to a mounting support, for example a wheel comprising a rim. Thus, each bead is notably intended to be in contact with a flange of the rim allowing it to be secured. Thus, the bead may be radially delimited on the inside by the radially innermost point of the tyre and radially delimited on the outside by the radially outermost point of the outer surface of the tyre bead to be in contact with a measuring rim of the tyre according to the ETRTO (European Tyre and Rim Technical Organization) 2021 standard manual when the tyre is inflated to its nominal pressure on this measuring rim.

Advantageously, the compositions are compositions which are not intended to be in contact with a tyre mounting support, so that the tyre comprising:
a carcass reinforcement comprising at least one carcass layer anchored in each bead, and
a tyre seating layer intended to be in contact with a tyre mounting support when the tyre is mounted on the mounting support,
the or each bead comprises at least one intermediate layer arranged axially between the carcass layer anchored in said bead and the seating layer, the intermediate layer comprising the rubber composition, preferably consisting of the rubber composition described previously.

In a first variant of these first embodiments, the carcass layer anchored in each bead is wound around a circumferential reinforcing element of each bead, so that an axially interior portion of the carcass layer anchored in each bead is arranged axially to the inside of an axially exterior portion of the carcass layer anchored in each bead, the intermediate layer comprises a “filling” layer extending radially outwards from each circumferential reinforcing element and arranged, at least in part, between the axially inner portion and the axially outer portion.

In a second variant of these first embodiments, each bead comprises an axially inner circumferential reinforcing element arranged axially inside the carcass layer anchored in each bead and an axially outer circumferential reinforcing element arranged axially outside the carcass layer anchored in each bead, the intermediate layer comprises a layer, known as a filling layer, extending axially between the seating layer and the axially outer reinforcing element.

Irrespective of the embodiment described previously, the seating layer is arranged axially outside the or each circumferential reinforcing element. The seating layer is thus arranged axially between the or each circumferential reinforcing element and the mounting support when the tyre is mounted on this support.

Conventionally, the mounting support is a rim.

The compositions described previously are, in accordance with a second embodiment of the invention, particularly useful for inclusion in the tread comprising:
a radially outer layer intended to be in contact with a ground on which the tyre runs when the tyre is new, and
a radially inner layer arranged radially inside the radially outer layer when the tyre is new, the radially inner layer comprising the rubber composition.

In a first variant of these second embodiments, the tyre comprising a regulatory wear indicator delimiting a regulatory wear threshold of the tread, there is a predetermined wear threshold on the tread which is strictly less than the regulatory wear threshold, beyond which predetermined threshold the radially inner layer is intended to be in contact with the ground on which the tyre runs.

In this embodiment, the radially inner layer may come into contact with the ground on which the tyre runs when the wear is between the predetermined threshold and the regulatory wear threshold.

In a second variant of these second embodiments, the tyre comprising a regulatory wear indicator delimiting a regulatory wear threshold of the tread, the radially inner layer is intended not to come into contact with the ground on which the tyre runs as long as the wear of the tread is less than or equal to the regulatory wear threshold.

In this embodiment, the radially inner layer cannot come into contact with the ground on which the tyre runs when the wear of the tyre is less than the wear corresponding to the regulatory wear threshold. In this second variant, the radially inner layer is generally called the underlayer or support layer.

Generally, the tread comprises cut-outs separating the tread blocks from each other, at the bottom of which cut-outs wear indicators are arranged. Such wear indicators are imposed for example by United Nations Regulations R30 and R54, US Standard FMVSS139 or Chinese Standard GB97743 and seek to indicate to the user of the tyre a regulatory tyre wear threshold beyond which it is dangerous to run, notably on wet ground. These wear indicators are thus referred to as regulatory wear indicators. Each regulatory wear indicator is formed by a protuberance extending radially from the bottom of the cutout, notably from the bottom of the deepest cutout, radially outwards over a radial height substantially equal to 1.6 mm. This radial height makes it possible to define the wear potential of the tyre, as the radial height between, when the tyre is new, the radially outermost point of the regulatory wear indicator and its projection onto the ground when the tyre is running.

As indicated previously, tyres, in particular for passenger vehicles, usually include:
two beads intended to come into contact with a mounting support;
two sidewalls extending the beads radially outwards and coming together in a crown comprising a tread and a crown reinforcement;
at least one carcass reinforcement extending radially in each sidewall and axially in the crown, radially on the inside of the crown reinforcement.

The invention will be understood more clearly on reading the following description, which is given solely by way of non-limiting example and with reference to the drawings, in which:

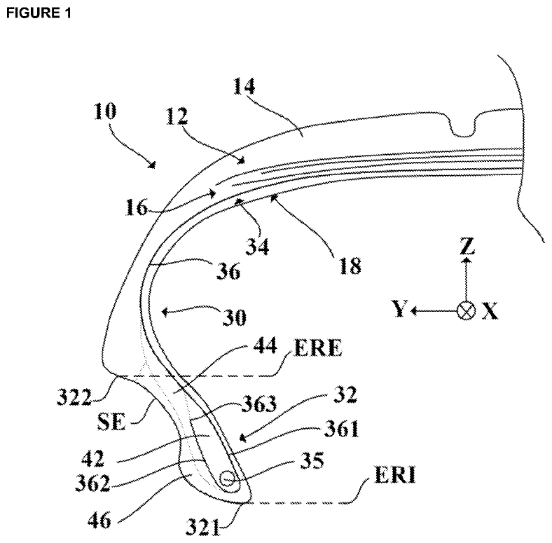

FIG. 1 is a view, in a meridian cross section plane parallel to the axis of rotation of the tyre, of a first variant of a first embodiment of the invention,

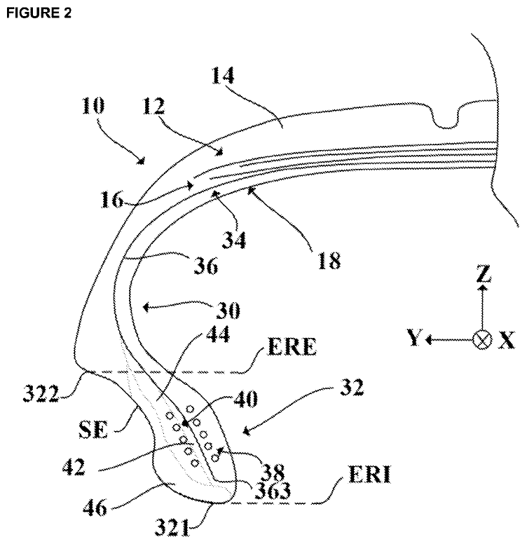

FIG. 2 is a view similar to that of FIG. 1 of a second variant of the first embodiment of the invention,

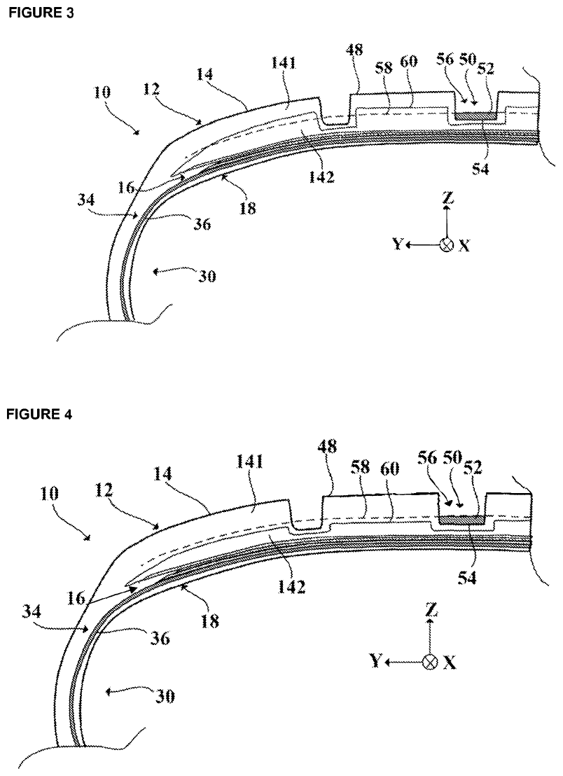

FIG. 3 is a view, in a meridian cross section plane parallel to the axis of rotation of the tyre, of a first variant of a second embodiment of the invention, and

FIG. 4 is a view similar to that of FIG. 3 of a second variant of the second embodiment of the invention.

A frame of reference X, Y, Z corresponding respectively to the usual axial (Y), radial (Z) and circumferential (X) directions of a tyre is shown in the figures relating to the tyre. FIG. 1 depicts a tyre in accordance with a first variant of a first embodiment of the invention and denoted by the general reference 10. The tyre 10 has a substantially toric shape about an axis of revolution substantially parallel to the axial direction Y. The tyre 10 is intended for a passenger vehicle.

The tyre 10 comprises a crown 12 comprising a tread 14 intended to come into contact with the ground when it is running and a crown reinforcement 16 extending in the crown 12 in the circumferential direction X. The tyre 10 also comprises a leaktight inner layer 18 that is leaktight with respect to an inflation gas and is intended to delimit an internal cavity with a mounting support of the tyre 10, once the tyre 10 has been mounted on the mounting support, for example a rim, this cavity being intended to be pressurized with the inflation gas.

The tyre 10 comprises two sidewalls 30 that extend the crown 12 radially inwards. The tyre 10 also includes two beads 32 radially on the inside of the sidewalls 30. Each bead 32 is intended to come into contact with a mounting support. Each sidewall 30 connects each bead 32 to the crown 12. Thus, the two sidewalls 30 extend the beads 32 radially outwards and come together in the crown 12. Each bead 32 is delimited radially on the inside by the radially innermost point 321 of the tyre 1. Each bead 32 is delimited radially to the outside by the radially outermost point 322 of the outer surface SE of bead 32 that is to be in contact with a measuring rim (not shown) of the tyre according to the ETRTO

(European Tyre and Rim Technical Organization) standard manual, 2021 when the tyre is inflated to its nominal pressure on this measuring rim. The radially innermost point 321 defines the radially inner end ERI of the bead 32 and point 322 defines the radially outer end ERE of the bead 32.

The tyre 10 comprises a carcass reinforcement 34. The crown reinforcement 16 is arranged radially between the tread 14 and the carcass reinforcement 34. The carcass reinforcement 34 comprises at least one carcass layer 36, in this case a single carcass layer 36, anchored in each bead 32. The carcass layer 36 extends radially in each sidewall 30 and axially in the crown 12, radially to the inside of the crown reinforcement 16.

For the purpose of anchoring the carcass layer 36, the carcass layer 36 is anchored in each bead 32 by winding around a circumferential reinforcing element 35 of each bead 32, in this case a bead wire, so that an axially interior portion 361 of the carcass layer 36 anchored in each bead 32 is arranged axially to the inside of an axially exterior portion 362 of the carcass layer 36 anchored in each bead 32 and so that each axial end 363 axially delimiting the carcass layer 36 anchored in each bead 32 is arranged radially to the outside of each circumferential reinforcing element 35.

Each bead 32 includes a first layer 42, referred to as a filling layer, extending radially outwards from each circumferential reinforcing element 35 and in contact with the carcass layer 36. The first layer 42 is arranged, at least in part, between the axially inner portion 361 and the axially outer portion 362.

Each bead 32 also includes a second layer 44, arranged axially outside the axially outer portion 362 and the first filling layer 42.

Each bead 32 also includes a third layer 46, known as the seating layer of the tyre 10. The third seating layer 46 is intended to be in contact with the mounting support for the tyre 10 when the tyre is mounted on this mounting support. The third seating layer 46 is arranged axially outside the circumferential reinforcing element 35 and more precisely axially between the circumferential reinforcing element 35 and the mounting support (not shown) when the tyre is mounted on this support.

At least one of the first, second and third layers 42, 44, 46 comprises, preferably consists of, a rubber composition in accordance with the invention. In the example illustrated, the first filling layer 42 is constituted of a rubber composition in accordance with the invention.

FIG. 2 depicts a tyre core according to a second variant of the first embodiment of the invention. The elements similar to those illustrated in FIG. 1 are denoted by identical references.

Unlike the tyre according to the first embodiment, the tyre 10 according to the second variant is such that, for the purpose of anchoring the carcass layer 36, the tyre 10 comprises an axially inner circumferential reinforcing element 38 arranged axially inside the carcass layer 36 and an axially outer circumferential reinforcing element 40 arranged axially outside the carcass layer 36. Here each reinforcing element 38, 40 comprises a continuous wire reinforcing element wound over a plurality of circumferential turns, for example as described in WO 2021/123522.

As with the first variant, at least one of the first, second and third layers 42, 44, 46 comprises, preferably consists of, a rubber composition in accordance with the invention.

In the example illustrated, the first filling layer 42 is constituted of a rubber composition in accordance with the invention.

FIG. 3 depicts a tyre core according to a first variant of a second embodiment of the invention. The elements similar to those illustrated in FIGS. 1 and 2 are denoted by identical references.

The tread 14 comprises a radially outer layer 141 intended to be in contact with a ground on which the tyre runs when the tyre is new and a radially inner layer 142 arranged radially inside the radially outer layer 141 when the tyre is new. When the tyre is new, the radially outer layer bears a tyre 10 running surface 48 intended to be in contact with the ground.

The tread 14 comprises several regulatory wear indicators 50 defining a regulatory wear threshold below which the tyre no longer complies with the corresponding regulation in terms of wear. In this case, the regulatory wear indicator 50 comprises a protuberance 52 extending radially from a base 54 of a cutout 56 radially outwards over a radial height ranging from 1.45 mm to 1.75 mm and substantially equal here to 1.6 mm. A regulatory wear trajectory 58 parallel to the rolling surface 48 of the tyre 10 and passing through the radially outer surface of the regulatory wear indicator(s) 50 is defined. In FIG. 3, the regulatory wear trajectory 58 is shown as a dashed line. As may be seen in FIG. 3, there is a predetermined wear threshold of the tread 14 which is strictly less than the regulatory wear threshold illustrated by the regulatory wear trajectory 58, beyond which predetermined threshold the radially inner layer 142 is intended to be in contact with the ground on which the tyre 10 runs. In FIG. 3, this predetermined threshold is illustrated by the interface 60 between the radially outer layer 141 and the radially inner layer 142.

FIG. 4 depicts a tyre according to a second variant of the second embodiment of the invention. The elements similar to those illustrated in FIG. 3 are denoted by identical references.

In contrast to the first variant illustrated in FIG. 3, the radially inner layer 142 is intended not to be in contact with the ground on which the tyre 10 runs as long as the wear of the tread 14 is less than or equal to the regulatory wear threshold. In other words, the radially inner layer 142 is intended to be in contact with the ground on which the tyre 10 runs when the wear of the tread 14 reaches a predetermined wear threshold beyond the regulatory wear threshold. In FIG. 4, this predetermined wear threshold is illustrated by the interface 60 between the radially outer layer 141 and the radially inner layer 142.

The tyre according to the invention is intended to equip motor vehicles of passenger vehicle type, SUVs (“Sport Utility Vehicles”), or two-wheel vehicles (notably motorcycles), or aircraft, or also industrial vehicles chosen from vans, heavy-duty vehicles—that is to say, underground trains, buses, heavy road transport vehicles (lorries, tractors, trailers) or off-road vehicles, such as heavy agricultural vehicles or civil engineering vehicles-, and others. Preferably, the tyre according to the invention is particularly suitable for equipping vehicles of passenger vehicle, van and SUV type.

The examples that follow are given for illustrative purposes. They should not in any case be considered to limit the present invention.

### Examples

### Measurement Method

### Dynamic Properties

The dynamic properties are measured on a viscosity analyser (Metravib VA4000) according to the standard ASTM D 5992-96. The response is recorded of a sample of vulcanized composition (cylindrical test specimens with a thickness of 4 mm and a cross section of 400 mm²), subjected to a simple alternating sinusoidal shear stress, at a frequency of 10 Hz, at a temperature of 40° C.

For the measurement of the tan(δ) loss factor, a sweep is performed with a strain amplitude from 0.1% to 10% peak-to-peak (outward cycle), and then from 10% to 0.1% peak-to-peak (return cycle).

The lower the value of tan(δ) at 40° C., the lower the hysteresis of the composition and thus the lower the rolling resistance. The results are expressed in terms of performance in base 100, that is to say that the value 100 is arbitrarily assigned to the control, in order to subsequently compare the tan(δ) at 40° C. (that is to say, the hysteresis—and thus the rolling resistance) of the various solutions tested. The value in base 100 is calculated according to the operation: (value of tan(δ) at 40° C. of the control/value of tan(δ) at 40° C. of the sample)*100. In this way, a lower value represents a reduction in the hysteresis performance (that is to say, an increase in the hysteresis), while a higher value represents a better hysteresis performance (that is to say, a lower hysteresis).

### Tensile Test Measurements

The tests were performed in accordance with the French standard NF T 46-002 of September 1988. All the tensile measurements were performed under standard conditions of temperature (23±2° C.) and hygrometry (50%+5% relative humidity), according to the French standard NF T 40-101 (December 1979).

At second elongation (that is to say, after accommodation), the nominal secant modulus, calculated by reducing to the initial cross section of the test specimen, (or apparent stress, in MPa) was measured at 10% elongation, denoted MA₁₀ (elastic tensile modulus at 10% elongation), on samples cured at 160° C. for 15 minutes. The results are expressed in base 100 relative to the control composition. When the value is greater than 100, the composition has a higher MA₁₀ modulus, and thus a higher stiffness, than the control composition.

### Mooney Plasticity

The Mooney plasticity measurement is performed according to the following principle and in accordance with the standard ASTM D-1646. The generally raw composition is moulded in a cylindrical chamber heated to a given temperature, usually 100° C. After preheating for one minute, an L-type rotor rotates within the test specimen at 2 revolutions/minute and the working torque for maintaining this movement is measured after rotating for 4 minutes. The Mooney plasticity (ML 1+4) is expressed in “Mooney units” (MU, with 1 MU=0.83 newton.metre). As is well known to those skilled in the art, the lower the Mooney plasticity, the easier the material is to work. All the values are indicated in base 100 relative to the given control.

### Fixing

The fixing time of the mixtures is determined according to the standard ISO 289-2 of February 2016, with the following deviations from the standard: the time used as a measure of fixing is counted from the moment the rotor starts rotating, without taking account of the moulding time; only t₅ is measured, irrespective of the rotor.

Thus, the fixing time (Fixing 115° C. t₅) is the time required (in minutes) excluding the minute of preheating from the moment the rotor starts rotating (2 rpm), to obtain a Mooney torque increase of 5 units relative to its minimum value, irrespective of the rotor used. This measurement is performed at 115°.

The results are expressed in base 100 relative to the control composition.

### Preparation of the Compositions

The compositions are manufactured in appropriate mixers, using two successive phases of preparation well known to those skilled in the art: a first phase of thermomechanical working or kneading (sometimes referred to as the “non-productive” phase) at high temperature, up to a maximum temperature of between 110° C. and 200° C., preferably between 130° C. and 180° C., followed by a second phase of mechanical working (sometimes referred to as the “productive” phase) at lower temperature, typically below 110° C., for example between 60° C. and 100° C., during which finishing phase the crosslinking or vulcanization system is conventionally incorporated.

The compositions are cured at 160° C. for 15 min.

### Tests

The formulations of the prepared compositions are described in Table 1 (components and content-unless otherwise indicated, the contents are expressed in phr).

The Mooney plasticity value is measured for each composition in the raw state, that is to say before vulcanization. The tensile elastic modulus at 10% elongation (MA10) and the tan(δ) loss factor are then measured in the cured state, thus after vulcanization.

TABLE 1
formulation and properties of compositions C1, C2 and INV1

| | C1 | C2 | INV1 |
|---|---|---|---|
| NR (1) | 100 | 100 | 100 |
| Carbon black (2) | 70 | — | 24 |
| Pyrolysed carbon black (3) | — | 87 | 58 |
| Antioxidant (5) | 2.5 | 2.5 | 2.5 |
| Reinforcing resin (6) | 5.5 | 7.2 | 7.2 |
| Reinforcing resin (7) | 6 | 7.8 | 7.8 |
| Stearic acid | 2 | 2 | 2 |
| Zinc oxide | 3 | 3 | 3 |
| Sulfur | 3 | 3.3 | 3.3 |
| Accelerator (8) | 2 | 2.2 | 2.2 |
| Curing agent (9) | 2.4 | 3.1 | 3.1 |
| MA₁₀ (base 100) | 100 | 71 | 98 |
| Fixing 115° C. t₅ (base 100) | 100 | 140 | 113 |
| Mooney (base 100) | 100 | 106 | 102 |
| tan(δ) 40° C. (base 100) | 100 | 99 | 97 |

(1) Natural rubber
(2) N326 conventional carbon black
(3) P550 pyrolysis carbon black from the company Scandinavian Enviro Systems (ash (%): 18.5; sulfur (%): 3; zinc (%): 4.5; STSA specific surface area: 56 m²/g (ASTM D6556-2021); void volume at 50 MPa: 44 ml/100 g (ASTM D7854-21))
(5) N-(1,3-Dimethylbutyl)-N-phenyl-para-phenylenediamine (Santoflex 6-PPD from Flexsys)
(6) Durez 28391 hydroxybenzene-based phenolic resin from the company Sumitomo
(7) Durez 12686 cardanol-based phenolic resin from the company Sumitomo
(8) N-Cyclohexyl-2-benzothiazolesulfenamide from the company Flexsys
(9) Hexamethylenetetranamine from the company Ineos Paraform

It will be noted that the compositions in accordance with the invention (INV1) afford, with a mixture of conventional carbon black and pyrolysis carbon black, stiffness similar to that of the control composition (composition C1) and improved rolling resistance (tan(δ)). The compositions in accordance with the present invention are moreover satisfactorily processable (Mooney viscosity similar to that of the control composition). The compositions of the present invention thus offer a good stiffness/rolling resistance/processability compromise while at the same time incorporating a higher content of recycled and biobased material.

### Reinforcing Resin Content

The formulations of the prepared compositions are described in Table 2 (components and content-unless otherwise indicated, the contents are expressed in phr).

The Mooney plasticity value is measured for each composition in the raw state, that is to say before vulcanization. The tensile elastic modulus at 10% elongation (MA₁₀) and the tan(δ) loss factor are then measured in the cured state, thus after vulcanization.

TABLE 2
formulation and properties of compositions C3 and INV2

| | C3 | INV2 |
|---|---|---|
| NR (1) | 100 | 100 |
| Carbon black (2) | 24 | 24 |
| Pyrolysed carbon black (3) | 58 | 58 |
| Antioxidant (5) | 2.5 | 2.5 |
| Reinforcing resin (6) | 18 | 6.6 |
| Reinforcing resin (7) | — | 7.2 |
| Stearic acid | 2 | 2 |
| Zinc oxide | 3 | 3 |
| Sulfur | 3.3 | 3.3 |
| Accelerator (8) | 2.2 | 2.2 |
| Curing agent (9) | 3.7 | 2.8 |
| MA₁₀ (base 100) | 100 | 108 |
| Fixing 115° C. t₅ (base 100) | 100 | 118 |
| Mooney (base 100) | 100 | 98 |
| tan(δ) 40° C. (base 100) | 100 | 99 |

(1) Natural rubber
(2) N326 conventional carbon black
(3) P550 pyrolysis carbon black from the company Scandinavian Enviro Systems (ash (%): 18.5; sulfur (%): 3; zinc (%): 4.5; STSA specific surface area: 56 m²/g (ASTM D6556-2021); void volume at 50 MPa: 44 ml/100 g (ASTM D7854-21))
(5) N-(1,3-Dimethylbutyl)-N-phenyl-para-phenylenediamine (Santoflex 6-PPD from Flexsys)
(6) Durez 28391 hydroxybenzene-based phenolic resin from the company Sumitomo
(7) Durez 12686 cardanol-based phenolic resin from the company Sumitomo
(8) N-Cyclohexyl-2-benzothiazolesulfenamide from the company Flexsys
(9) Hexamethylenetetranamine from the company Ineos Paraform

It is observed that the use of a reinforcing resin blend allows the total amount of reinforcing resins used in the rubber compositions to be reduced (comparison of compositions C3 and INV2). Specifically, composition C3 comprising 18 phr of a hydroxybenzene-based phenolic resin has a lower stiffness than a composition that is useful in the context of the present invention, which has a total reinforcing resin content of 13.8 phr.

A stiffness similar to that of the compositions of the present invention could only be obtained for compositions comprising, as reinforcing fillers, a mixture of carbon black and pyrolysis carbon black by using contents of resin (6)—used alone—which are much higher than the total content of reinforcing resins used in the compositions of the present invention (comparison C3 and INV2).

1.-17. (canceled)

18. A tire comprising two beads, at least one of the beads comprising a rubber composition based on:
an elastomeric matrix predominantly by mass comprising natural rubber;
at least 65 phr of reinforcing fillers, the reinforcing fillers consisting of 40 to 70 phr of pyrolysis carbon black and 10 to 40 phr of carbon black, a ratio of a mass of the pyrolysis carbon black to a total mass of reinforcing fillers ranging from 0.60 to 0.75;
10 to 20 phr of a reinforcing resin mixture, the reinforcing resin mixture comprising a cardanol-based phenolic resin, a ratio of a mass of the cardanol-based phenolic resin to a total mass of reinforcing resins ranging from 0.1 to 0.7;
a curing agent; and
a crosslinking system.

19. The tire according to claim 18, wherein the ratio of the mass of the cardanol-based phenolic resin to the total mass of reinforcing resins ranges from 0.2 to 0.6.

20. The tire according to claim 18 further comprising:
a carcass reinforcement comprising at least one carcass layer anchored in each bead; and
a tire seating layer intended to be in contact with a tire mounting support when the tire is mounted on the tire mounting support,
the or each bead comprising at least one intermediate layer arranged axially between the at least one carcass layer anchored in each bead and the seating layer, the intermediate layer comprising the rubber composition.

21. The tire according to claim 20, wherein the at least one carcass layer anchored in each bead is wound around a circumferential reinforcing element of each bead, so that an axially interior portion of the at least one carcass layer anchored in each bead is arranged axially to an inside of an axially exterior portion of the at least one carcass layer anchored in each bead, and the intermediate layer comprises a filling layer extending radially outwards from each circumferential reinforcing element and arranged, at least in part, between the axially interior portion and the axially exterior portion.

22. The tire according to claim 20, wherein each bead comprises an axially inner circumferential reinforcing element arranged axially inside the at least one carcass layer anchored in each bead and an axially outer circumferential reinforcing element arranged axially outside the at least one carcass layer anchored in each bead, and the intermediate layer comprises a filling layer extending axially between the seating layer and the axially outer circumferential reinforcing element.

23. A tire comprising a tread comprising:
a radially outer layer intended to be in contact with a ground on which the tire runs when the tire is new; and
a radially inner layer arranged radially inside the radially outer layer when the tire is new, the radially inner layer comprising a rubber composition based on:
an elastomeric matrix predominantly by mass comprising natural rubber;
at least 65 phr of reinforcing fillers, the reinforcing fillers consisting of 40 to 70 phr of pyrolysis carbon black and 10 to 40 phr of carbon black, a ratio of a mass of the pyrolysis carbon black to a total mass of reinforcing fillers ranging from 0.60 to 0.75;
10 to 20 phr of a reinforcing resin mixture, the reinforcing resin mixture comprising a cardanol-based phenolic resin, a ratio of a mass of the cardanol-based phenolic resin to a total mass of reinforcing resins ranging from 0.1 to 0.7;
a curing agent; and
a crosslinking system.

24. The tire according to claim 23, wherein the ratio of the mass of the cardanol-based phenolic resin to the total mass of reinforcing resins ranges from 0.2 to 0.6.

25. The tire according to claim 23 further comprising a regulatory wear indicator delimiting a regulatory wear threshold of the tread, and a predetermined wear threshold of the tread which is strictly less than the regulatory wear threshold, beyond which predetermined threshold the radially inner layer is intended to be in contact with the ground on which the tire runs.

26. The tire according to claim 23 further comprising a regulatory wear indicator delimiting a regulatory wear threshold of the tread,
wherein the radially inner layer is intended not to come into contact with the ground on which the tire runs as long as the wear of the tread is less than or equal to the regulatory wear threshold.

27. The tire according to claim 18, wherein the elastomeric matrix comprises from 50 to 100 phr of natural rubber.

28. The tire according to claim 18, wherein the elastomeric matrix further comprises a styrene-butadiene copolymer (SBR).

29. The tire according to claim 18, wherein the reinforcing resin mixture comprises a cardanol-based phenolic resin and at least one other reinforcing resin selected from the group consisting of phenolic resins, epoxy resins, benzoxazine resins, polyurethane resins and aminoplast resins.

30. The tire according to claim 29, wherein the reinforcing resin mixture consists of a cardanol-based phenolic resin and another phenolic resin.

31. The tire according to claim 18, wherein the crosslinking system is a vulcanization system based on molecular sulfur and/or a sulfur-donating agent.

32. The tire according to claim 18, wherein the pyrolysis carbon black has an ash content ranging from 5% to 30% by weight, relative to a total weight of the pyrolysis carbon black.

33. The tire according to claim 18, wherein the pyrolysis carbon black has a sulfur content of greater than 2% by weight, relative to a total weight of the pyrolysis carbon black.

34. The tire according to claim 18, wherein the rubber composition further comprises one or more agents selected from the group consisting of plasticizers, non-reinforcing fillers, pigments, protective agents, chemical anti-ozonants, antioxidants and anti-fatigue agents.

35. The tire according to claim 19, wherein the ratio of the mass of the cardanol-based phenolic resin to the total mass of reinforcing resins ranges from 0.4 to 0.6.

36. The tire according to claim 20, wherein the at least one intermediate layer consists of the rubber composition.

37. The tire according to claim 23, wherein the ratio of the mass of the cardanol-based phenolic resin to the total mass of reinforcing resins ranges from 0.4 to 0.6.

38. The tire according to claim 27, wherein the elastomeric matrix comprises 75 to 100 phr of natural rubber.

39. The tire according to claim 30, wherein the reinforcing resin mixture consists of a cardanol-based phenolic resin and another hydroxybenzene-based phenolic resin.

40. The tire according to claim 31, wherein the crosslinking system comprises between 0.5 and 12 phr of sulfur.

41. The tire according to claim 23, wherein the crosslinking system comprises between 3 and 9 phr of sulfur.

42. The tire according to claim 32, wherein the pyrolysis carbon black has an ash content ranging from 8% to 25% by weight, relative to the total weight of the pyrolysis carbon black.

43. The tire according to claim 33, wherein the pyrolysis carbon black has a sulfur content ranging from 2.5% to 5% by weight, relative to the total weight of the pyrolysis carbon black.
